(19) United States
(12) Patent Application Publication
(10) Pub. No.: US 2024/0285129 A1
(43) Pub. Date: Aug. 29, 2024

(54) FOOD BLENDER AND SCRAPER ASSEMBLY FOR A FOOD BLENDER

(71) Applicant: CONAIR LLC, STAMFORD, CT (US)

(72) Inventor: DAVID WILLIAM BECKSTROM, ROXBURY, CT (US)

(73) Assignee: CONAIR LLC, STAMFORD, CT (US)

(21) Appl. No.: 18/113,352

(22) Filed: Feb. 23, 2023

(51) Int. Cl. A47J 43/08

(52) U.S. Cl. CPC A47J 43/085; A47J 43/082

(57) ABSTRACT

A food processing system includes a processing container having a motor-driven processing blade positioned at a bottom of the processing container, a lid receivable atop the processing container, a motor-driven scraper assembly connected to the lid and being configured to scrape interior sidewalls of the processing container, the motor-driven scraper assembly having a hub, and a motor having a rotatable drive coupling, at least the drive coupling being moveable between a raised position where the drive coupling is vertically spaced from the hub of the motor-driven scraper assembly, and a lowered position where the drive coupling is engaged with the hub.

### FIELD OF THE INVENTION

The present invention relates generally to food processing devices and, more particularly, to a food blender and scraper assembly for a food blender.

### BACKGROUND OF THE INVENTION

Food processing devices providing a number of different types of food processing operations such as blending, mixing, grinding, chopping, slicing, grating, shredding, and the like, are well known. Existing food processing devices typically include a base housing an electric motor, a drive shaft driven by the motor, a blending or processing container receivable on the base and a lid or cover releasably mounted to the container. A rotatably driven blade is mounted in the bottom of the container and is engageable with the drive shaft so as to be driven by the motor to process one or more food items inside the container.

Certain existing food processing devices, such as that disclosed in U.S. Patent Application U.S. Patent Application Publication No. 2022/0142410, which is incorporated by reference herein in its entirety, also employ a motorized dasher or scraper integrated with the lid, which is operable to scrape foodstuffs from the sides of the processing container during processing, without necessitating cessation of the processing operation or removal of the container lid. Such a scraper or dasher is particularly useful when processing thicker products, such as nut butters, hummus, shakes, smoothies, and the like.

Top-mounted scraper assemblies, however, can sometimes be cumbersome to operate or configure, and can require various manual steps to couple and decouple the top-mounted scraper motor from the scraper blades positioned within the processing container. In view of the above, there is a need for a food blender and a scraper assembly for a food blender which provides for easy and reliable selective interconnection between the output shaft of the scraper motor and the scraper blades within the processing container.

### SUMMARY OF THE INVENTION

It is an object of the present invention to provide a food processing system.

It is another object of the present invention to provide a food processing system having a motor driven dasher or scraper assembly for removing foodstuffs from the sidewalls of a processing container during operation.

It is another object of the present invention to provide a food processing system having a scraper motor that can be easily engaged with, and disengaged from, the scraper blades of the scraper assembly.

It is another object of the present invention to provide a food processing system having a motor mount for a scraper motor.

These and other objects are achieved by the present invention.

According to an embodiment of the invention, a food processing system includes a processing container having a motor-driven processing blade positioned at a bottom of the processing container, a lid receivable atop the processing container, a motor-driven scraper assembly connected to the lid and being configured to scrape interior sidewalls of the processing container, the motor-driven scraper assembly having a hub, and a motor having a rotatable drive coupling, at least the drive coupling being moveable between a raised position where the drive coupling is vertically spaced from the hub of the motor-driven scraper assembly, and a lowered position where the drive coupling is engaged with the hub.

According to another embodiment of the invention, a method for food processing includes the steps of coupling a scraper assembly to a processing container such that a scraper blade of the scraper assembly is disposed within the processing container, positioning the processing container on a base of a food processor so as to engage a blade hub of the processing container with a rotatable output shaft of a motor housed in the base, lowering a scraper motor to drivingly connect a drive coupling of the scraper motor with a drive hub of the scraper assembly, and actuating the scraper motor to rotate the scraper blade within the processing container.

According to yet another embodiment of the invention, a food processing system includes a base having a motor, a processing container having a motor-driven processing blade positioned at a bottom of the processing container and engageable with an output shaft of the motor in the base, a lid receivable atop the processing container, a scraper assembly connected to the lid and having at least one scraper blade disposed in the processing container and being configured to scrape interior sidewalls of the processing container, and a scraper motor positioned above the processing container, the scraper motor having a rotatable drive coupling that is selectively engageable with the scraper assembly, the scraper motor being configured to rotate the at least one scraper blade upon actuation of the scraper motor. The drive coupling of the scraper motor is moveable between a raised position where the drive coupling is vertically spaced from the scraper assembly, and a lowered position where the drive coupling is engaged with the scraper assembly.

### BRIEF DESCRIPTION OF THE DRAWINGS

The present invention will be better understood from reading the following description of non-limiting embodiments, with reference to the attached drawings, wherein below:

FIG. 1 is a perspective view of a food processing system according to an embodiment of the present invention, showing a scraper motor in a lowered position.

FIG. 2 is a perspective view of the food processing system of FIG. 2, showing the scraper motor in a raised position.

FIG. 3 is a front, elevational view of the food processing system of FIG. 1.

FIG. 4 is a right side elevational view of the motor mount of the food processing system of FIG. 1, showing a lowered position of the motor.

FIG. 5 is an exploded, perspective view of the food processing system of FIG. 1

FIG. 6 is a partial cross-sectional, perspective view of the food processing system of FIG. 1, illustrating the scraper motor in the lowered position.

FIG. 7 is a partial cross-sectional, perspective view of the food processing system of FIG. 1, illustrating the scraper motor in the raised position.

FIG. 8 is an enlarged, perspective view of the scraper assembly of the food processing system, showing the scraper motor in the raised position.

FIG. 9 is an enlarged, side elevational view of the scraper assembly of the food processing system, showing the scraper motor in the lowered position.

FIG. 10 is an enlarged, side elevational view of the scraper assembly of the food processing system, showing the scraper motor in the raised position.

FIG. 11 is a side, cross-sectional view of the scraper assembly of the food processing system, showing the scraper motor in the raised position.

FIG. 12 is an enlarged, bottom perspective view of the scraper motor of the food processing system.

FIG. 13 is a perspective view of the food processing system of FIG. 1, shown with a sound enclosure in an open position.

FIG. 14 is a perspective view of the food processing system of FIG. 1, shown with the sound enclosure in a closed position.

### DETAILED DESCRIPTION OF THE PREFERRED EMBODIMENT

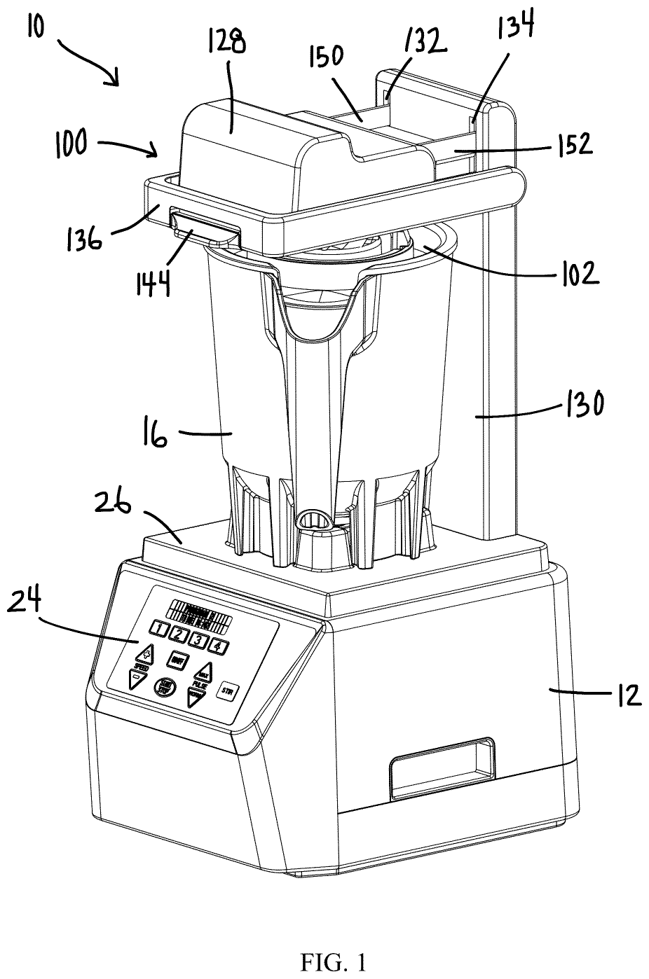

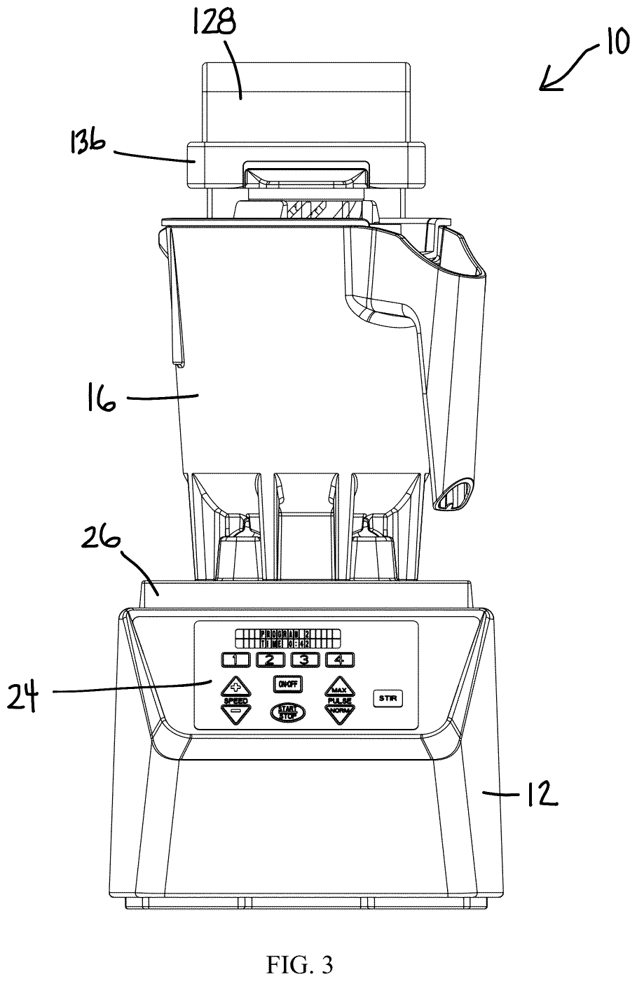

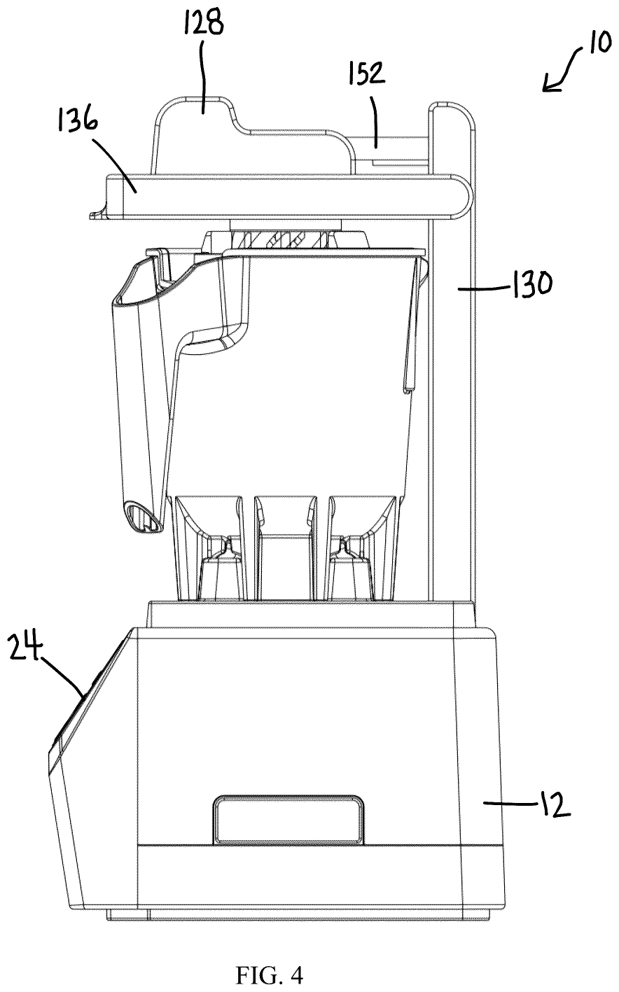

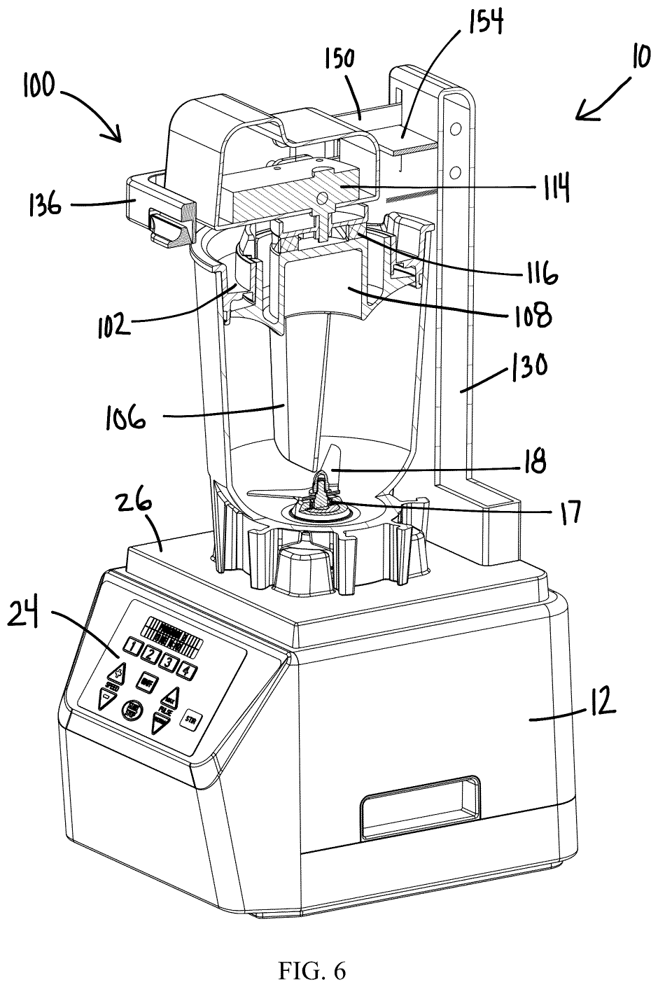

With reference to FIGS. 1-7, a food processing system 10 (also referred to herein as food processing device 10) according to an embodiment of the present invention is illustrated. As shown therein, the food processing device 10 includes a base 12 which houses a motor (not shown) drivingly connected a rotatable output shaft 19 extending upwardly from the base 12, as is known in the art. The food processing device 10 further includes a processing container 16 having a set of rotating blades 18 interior to the processing container 16 at the bottom thereof. The processing container 16 is receivable atop the base 12 such that a splined hub 17 of the processing container 16 (connected to the blades 18) matingly engages a correspondingly splined end of the rotatable output shaft 19 extending from the base 12, such that the blades 18 can be rotatably driven by the motor via the output shaft, as is known in the art. The motor may be powered by a connected electrical cord for connection to a standard outlet, however, an internal power supply (e.g., battery) may also be utilized to power the motor.

Base 12 includes a control interface 24 on one of its surfaces allowing for user control of processing operations. In particular, the control interface 24 can be utilized to turn on and off the food processing device 10, to adjust the speed of rotation of the motor, as well as control other operations of the food processing device 10 via a controller (not shown) contained within the base 12. Base 12 also includes a raised pedestal 26 on a top surface thereof, which is configured to be received in a lower portion of the processing container 16 when the processing container is placed atop the base and engaged with the output shaft of the motor. Pedestal 26 may include one or more pads which, when received by the base portion of the container 16, prevent the container 16 from rotating when the motor within base 12 is actuated. In addition, pedestal 26 also receives the splined end of the rotating motor shaft therethrough.

With further reference to FIGS. 1-7, the food processing device 10 additionally includes a motor-driven dasher or scraper assembly 100, which is operable to scrape food from the interior sidewalls of the container 16 during processing. The motor-driven dasher assembly 100 includes a lid 102 configured to be received atop the processing container 16, and a scraper device or dasher 104 operatively connected to the lid 102. The dasher 104 includes one or more scraper blades 106 that extend into the processing container 16 for scraping the interior sidewalls of the container 16, and a centrally located hub 108 that is configured to matingly receive a drive coupling 110 of an output shaft of a dasher motor 114, as described in detail below. In an embodiment, the dasher 104 may be configured generally similar to the dasher disclosed in U.S. Patent Application Publication No. 2022/0142410.

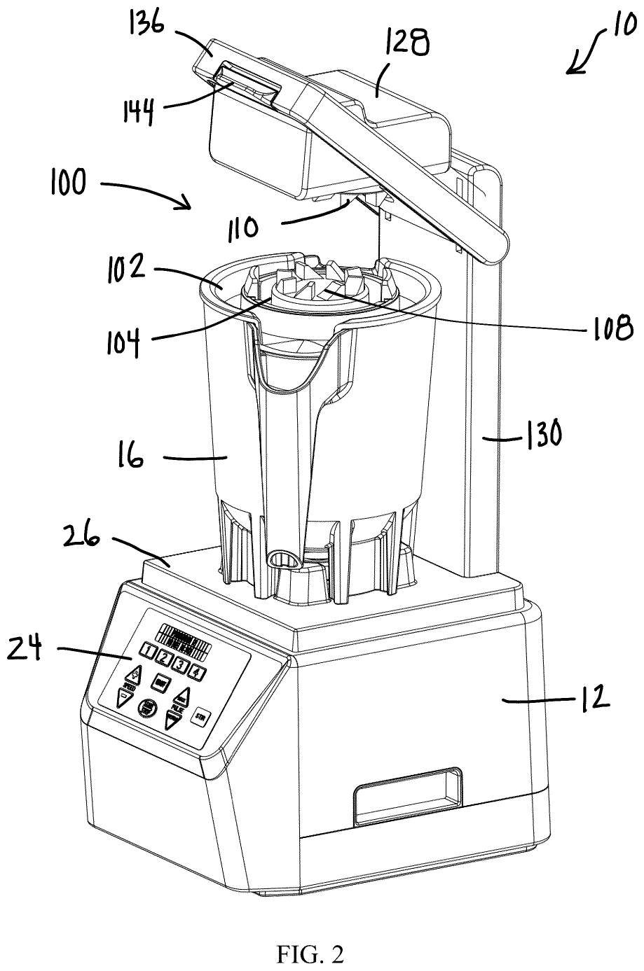

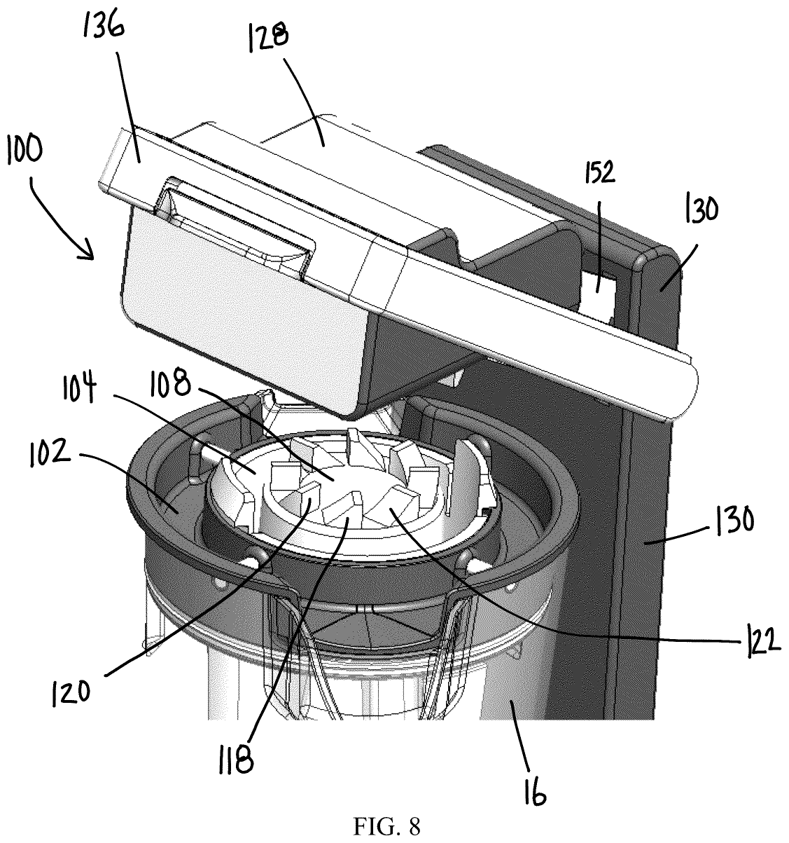

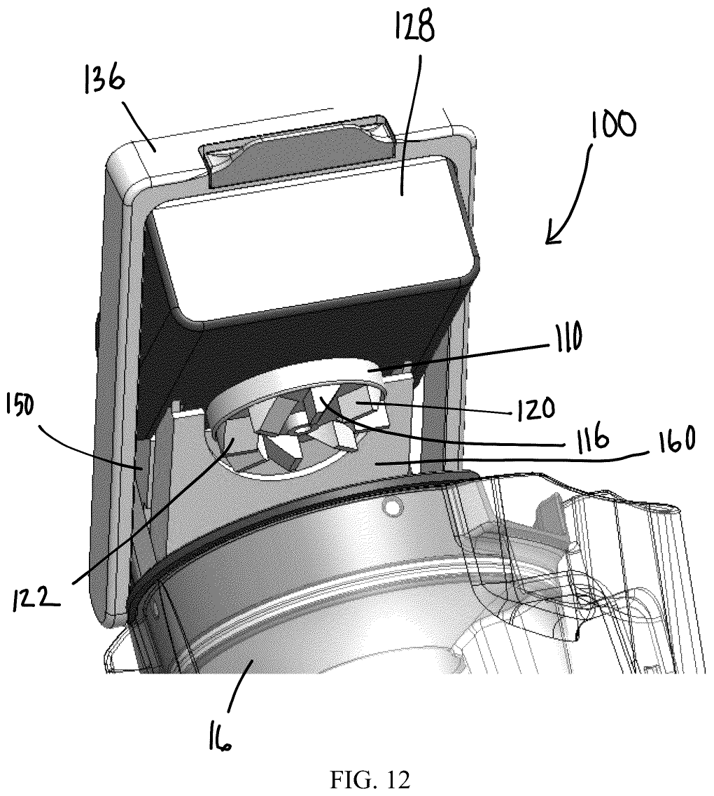

As indicated above, the dasher assembly 100 further includes a motor 114 having a rotatable drive coupling 110 driven by the motor 114, which is configured to interface with the hub 108 of the dasher 104 for rotating the scraper blades 106 of the dasher 104. In an embodiment, the drive coupling 110 includes a plurality of fins 116 arranged in an annular configuration, which are configured to mate with a plurality of complimentary fins 118 on the hub 108 of the dasher 104, as best shown in FIGS. 2, 5, 8 and 12. The angled fins may each have a substantially vertical face 120 and an opposing angled face 122. When mated with one another, the vertical faces 120 of the fins 116 of the drive coupling 110 contact the vertical faces 120 of the fins 118 on the hub 108, so that rotational motion of the drive coupling 110 can be transferred to the hub 108 of the dasher 104, as discussed hereinafter. The angled faces 122 of the fins 116, 118 facilitate engagement of the drive coupling 110 with the hub 108. It is contemplated, however, that other coupling arrangements, such as splined connections and the like, may also be utilized without departing from the broader aspects of the invention.

In an embodiment, the motor 114 is contained within a housing 128 that is arranged generally above the processing container 16, and is supported by a vertical support member 130 that is attached to the base 12 of the food processing device 10. In this respect, the housing 128 is cantilevered over the hub 108 of the dasher 104. The housing 128 (including the motor 114 and drive coupling 110 housed there) is moveable between a raised position and a lowered position, as discussed below.

To effect movement of the housing 128 between the raised position and the lowered position, the scraper assembly 100 includes a lifter handle 136 operatively connected to the housing 128. The lifter handle 136 is generally U-shaped and has a pair of opposed arm members 138, 140 that are pivotally connected to the vertical support member 130 at their distal ends. In an embodiment, the lifter handle 136 may also include a cross-member 142, having a button actuator 144, that can be grasped by a user to rotate the lifter handle 136 to effect raising and lowering of the housing 128. In an embodiment, the button actuator 144 is configured so that the lifter handle 136 can only be moved up and down when the button actuator 144 is depressed. In an embodiment, the actuator 144 is configured so that the lifter handle 136 is configured to lock in the raised and lowered positions unless the button actuator 144 is depressed.

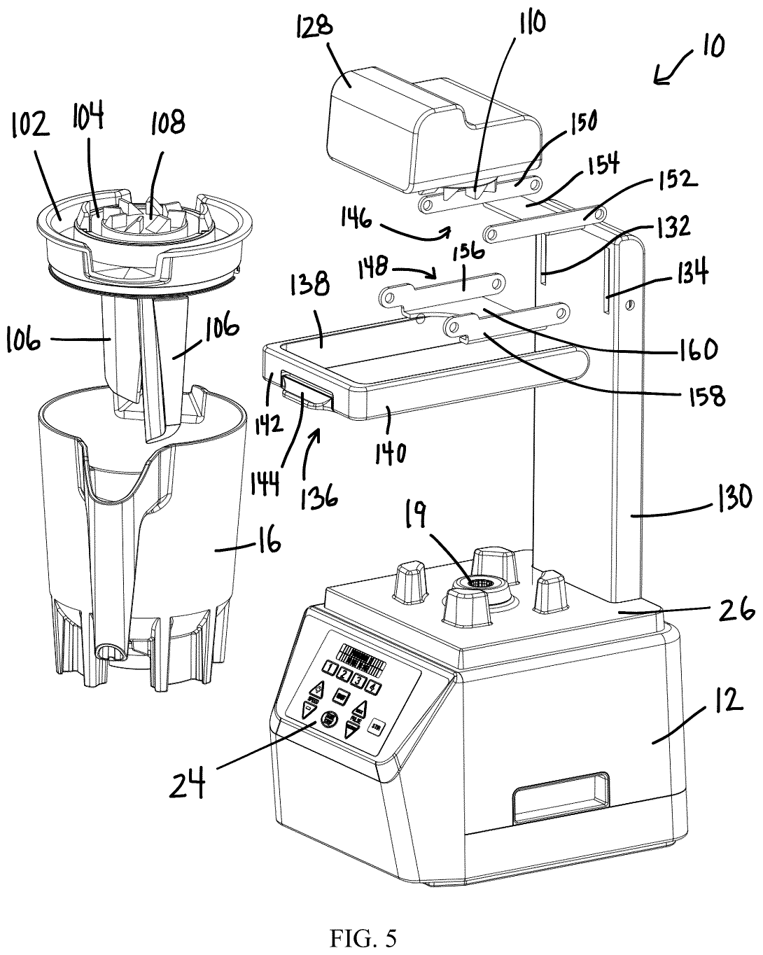

With specific reference to FIG. 5, the housing 128, in addition to the lifter handle 136, is connected to the support member 130 by a pair of linkages, including a first, upper linkage 146 and a second, lower linkage 148. The upper linkage 146 includes first and second linkage members 150, 152 and a rigid connection member or plate 154 interconnecting the first and second linkage members 150, 152. The distal ends of the first and second linkage members 150, 152 are received in the slots 132, 134 in the front face of the support member 130 and are pivotally connected to the support member 130. The proximal ends of the first and second linkage members 150, 152 are pivotally connected to the motor housing 128. Similarly, the lower linkage 148 includes first and second linkage members 156, 158 and a rigid connection member or plate 160 interconnecting the first and second linkage members 156, 158. The distal ends of the first and second linkage members 156, 158 of the lower linkage 148 are likewise received in the slots 132, 134 in the front face of the support member 130 and are pivotally connected to the support member 130. The proximal ends of the first and second linkage members 156, 158 of the lower linkage 148 are, likewise, pivotally connected to the motor housing 128. In an embodiment, the rigid plates 154, 160 may not be present. This four-bar linkage assembly provides for raising and lowering of the scraper motor 114 and drive coupling 110 to perform side scraping operations, in addition to standard food processing within the processing container 16, as desired.

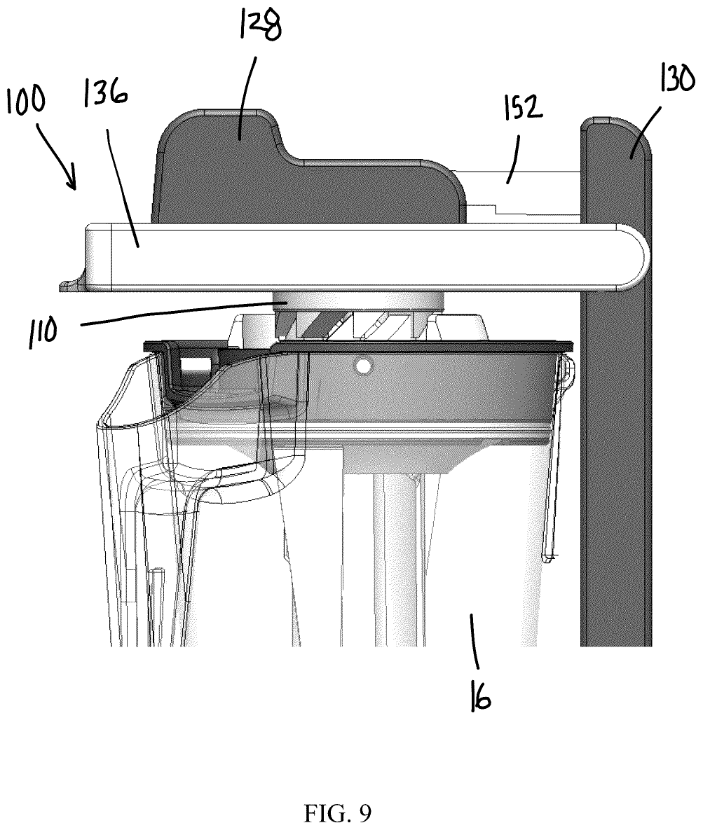

In operation, ingredients to be processed can be processed can be placed within the processing container 16, and the lid 102 and scraper device 104 can be placed on the processing container 16. The processing container 16 may then be placed on the base 12 so that the output shaft 19 of the motor within the base 12 is engaged with the hub 17 of the processing container 16. Alternatively, the processing container 16 may be placed on the base 12 before adding the ingredients. A user may then grasp the lifter handle 136 and depress button 144, and rotate the lifter handle 136 downward to move the housing 128 to the lowered position where the drive coupling 110 of the dasher/scraper motor 114 engages the hub 108 of the scraper device 104 so that rotational movement of the drive coupling 110 can impart a corresponding rotation of the hub 108 and scraper blades 106 within the processing container 16, as illustrated in FIGS. 1, 3, 4, 6 and 9. In particular, as the handle 136 is lowered, the first and second linkages 146, 148 pivot downwardly about their distal ends within the slots 132, 134, causing the housing 128, motor 114 and drive coupling 110 to move in an arc in the downward and forward directions until the drive coupling 110 and hub 108 are interconnected and are coaxial.

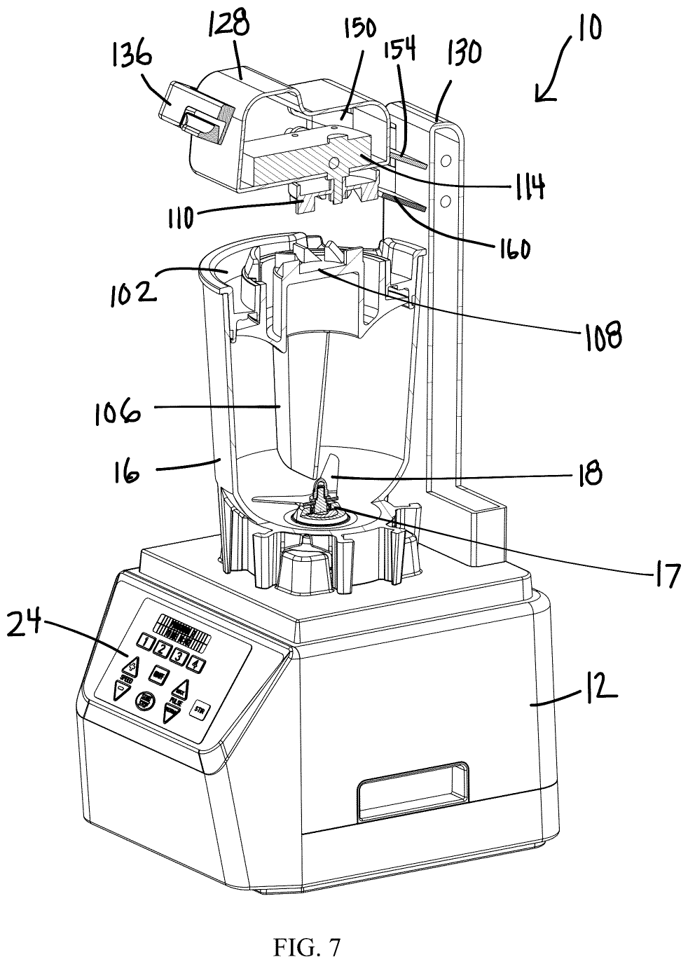

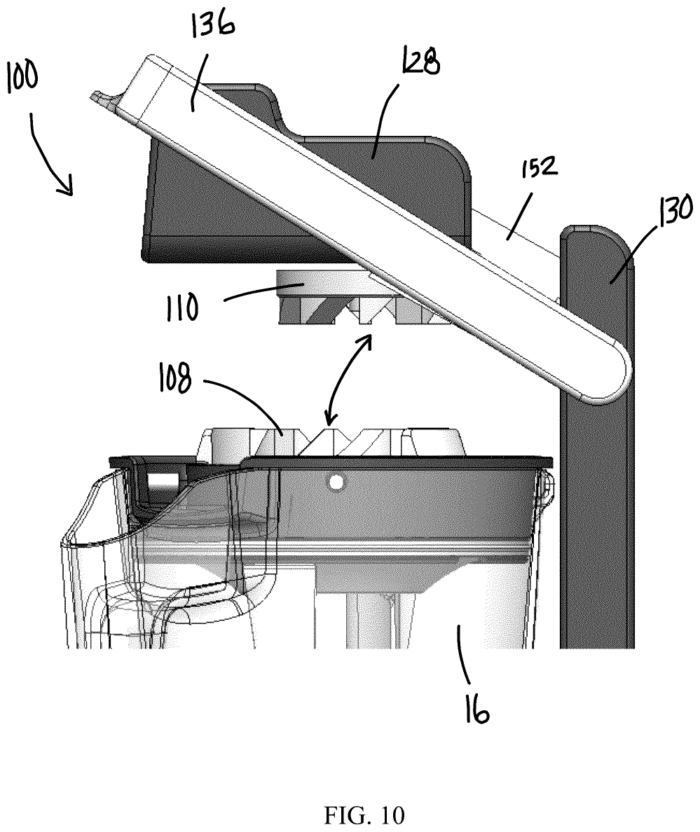

After processing, drive coupling 110 and motor 114 can be disengaged from the scraper 104 by moving the housing 128 to its raised position, as shown in FIGS. 2, 7, 8, 10, 11 and 12. This is carried out by grasping the lifter handle 136, depressing button 144, and rotating the lifter handle 136 upward. During this movement, the housing moves in an upward arc towards the support member 130, decoupling drive coupling 110 from the hub 108 of the scraper 104. In this raised position, the axis of the drive coupling 110 is displaced above, and rearward of the hub 108 due to the configuration of the rigid linkages 146, 148 (which are pivotally connected to the support member 130 and the housing 128 at respective ends thereof), as best shown in FIGS. 7 and 10. In this position, the processing container 16 can be removed from the base 12. Accordingly, the food processing device 10 is configured so that the dasher motor 114 moves upward and rearward, and down and forward (i.e., out of or into engagement with the drive hub 108 of the dasher 104) in response movement of the lifter handle 136.

As disclosed above, the drive coupling 110 and hub 108 of the scraper device 108 have a plurality of fins 116, 118 each having a vertical surface and an angled surface, which facilitate smooth and reliable connection between the drive coupling 110 and the hub 108 when the motor 114 is in the lowered position. For example, when the motor 114 is lowered, any misalignment between the fins 116 of the drive coupling 110 and the fins of the hub 108 is automatically corrected by contacting engagement between the respective inclined surfaces 122 of the fins 116, 118. In particular, contacting of the respective inclined surfaces 122 during lowering of the housing 128 causes the drive coupling 110 and/or the hub 108 to rotate slightly until the respective vertical faces 120 of the fins 116, 118 are aligned with one another.

In an embodiment, the motor 114 of the dasher assembly 100 may be operable using control panel 24 (via wired or wireless communication between the control panel 24 and the motor 114). In other embodiments, the food processing device 10 may be configured such that the motor 114 is automatically activated when the drive coupling 110 is engaged with the hub 108 of the dasher 104 (e.g., via a sensor that detects the position of the lifter handle 136 of the position of the housing 128 along the vertical support member 130). In yet other embodiments, the dasher assembly 100 may have a dedicated control interface (e.g., a control panel located on the housing 128 or elsewhere on the food processing device 10).

The present invention thus provides a means for easily and selectively engaging and disengaging the hub 108 of a top-mounted dasher assembly 104 with the drive coupling 110 of the dasher motor 114. By raising the dasher motor 114 and drive coupling 110 above and out of engagement with the processing container 16, the processing container 16 can be removed from the base 12 without much effort. As a result, and ease of use and level of user convenience heretofore not seen in the art may be realized.

While the present invention discloses a moveable motor housing that can be raised lowered so as bring the output shaft of the dasher motor into engagement with a drive hub 110 of a dasher assembly, the present invention is not intended to be so limited in this regard. In particular, it is contemplated that the motor housing 128, motor 114 and drive coupling 110 may be in fixed position, and the processing container 16 may be raised or lifted to bring the hub 108 into engagement with the drive coupling 110 of the dasher motor 114.

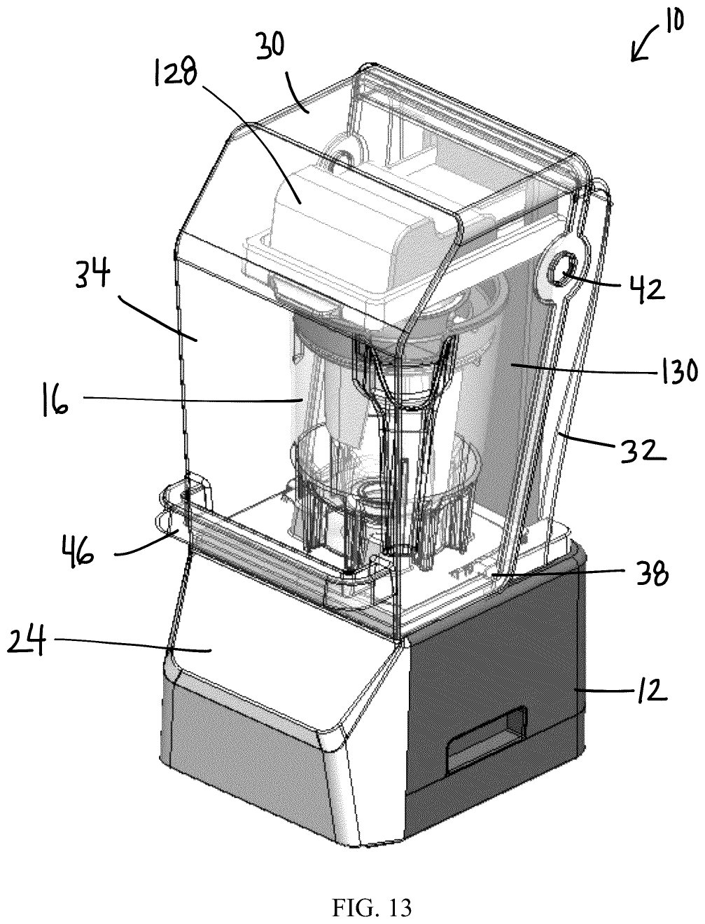

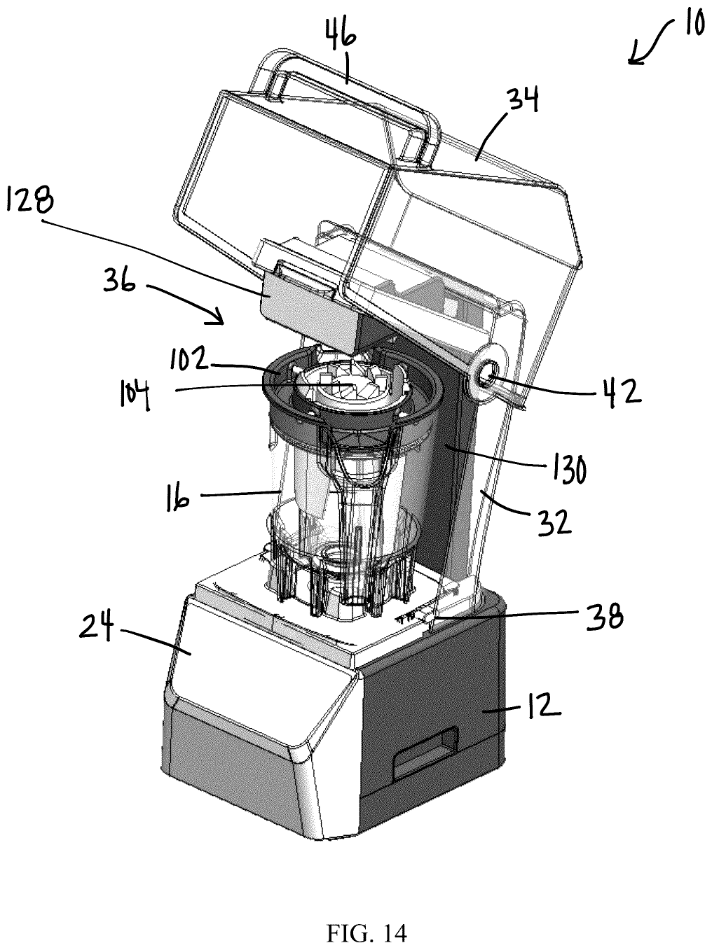

Turning now to FIGS. 13 and 14, the food processing device 10 may additionally include a sound enclosure 30 of the type known in the art. For example, the sound enclosure 30 includes a rear enclosure member 32 forming a first half of a housing, and a front enclosure member 34 forming a second half of a housing, which together define an interior space 36 therebetween for accommodating the container 16. The rear enclosure member 32 is removably connected to the base 12 via a pair of projections 38 on the base 12 that are received in corresponding recesses or apertures adjacent to the bottom edge of the rear enclosure member 32. In an embodiment, the projections extend through the pedestal 26. Other attachment mechanisms for attaching the rear enclosure member 34 to the base 12, such as a tongue and groove attachment, fasteners including thumb screws, magnetic means, and the like may also be utilized without departing from the broader aspects of the invention. In addition, it is contemplated that the rear enclosure member 32 may be fixedly (i.e., not removably) attached to the base 12.

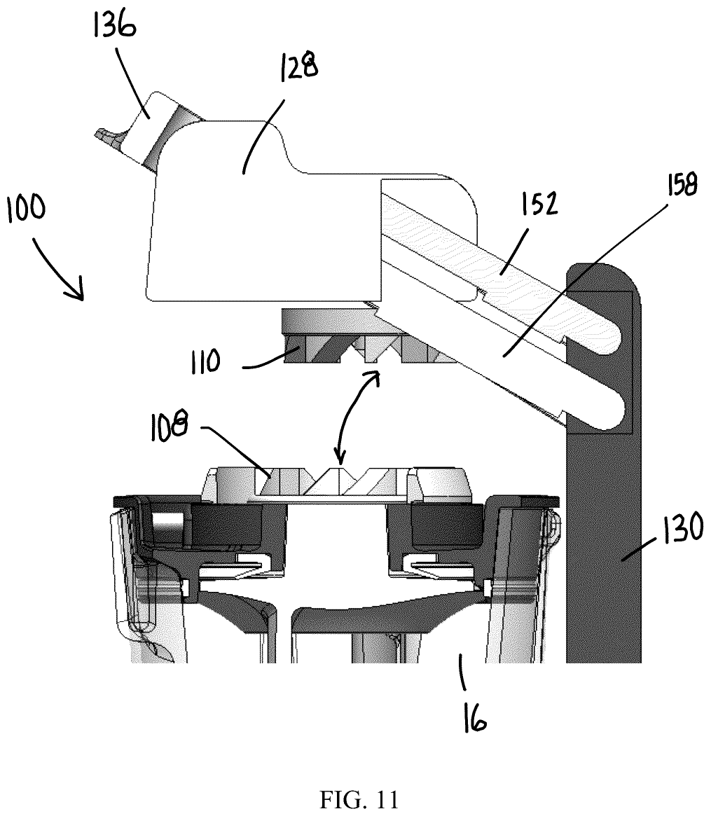

The front enclosure member 34 is pivotally connected to the rear enclosure member 32 at a pair of opposed pivot points 42. The front enclosure member 34 also includes a handle 46 located adjacent to a bottom edge of the front enclosure member 34 for rotating the front enclosure member 34 between a closed position, shown in FIG. 10, and an open position, shown in FIG. 11 (providing access to the interior space 36 for insertion and removal of the container 16 from the base 12). The front enclosure member 34, however, may be pivotally connected to the rear enclosure member 32 by any means known in the art, such that it can be moved from a closed position to an open position, allowing access to the interior space 36 of enclosure 30 for insertion and/or removal of the container 16.

It is contemplated that the enclosure 30 may be made of any material known in the art, however, it is preferred that the rear enclosure member 32 and front enclosure member 34 are may of a transparent or translucent material such as, for example, thermoplastic or polycarbonate, so that the container 16 can be viewed when positioned on the base 12 with the front enclosure member 34 in the closed position.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A food processing system, comprising:
a processing container having a motor-driven processing blade positioned at a bottom of the processing container;
a lid receivable atop the processing container;
a motor-driven scraper assembly connected to the lid and being configured to scrape interior sidewalls of the processing container, the motor-driven scraper assembly having a hub; and
a motor having a rotatable drive coupling, at least the drive coupling being moveable between a raised position where the drive coupling is vertically spaced from the hub of the motor-driven scraper assembly, and a lowered position where the drive coupling is engaged with the hub.

2. The food processing system of claim 1, wherein:
in the raised position, the drive coupling is positioned vertically and rearwardly from the hub of the scraper assembly.

3. The food processing system of claim 1, further comprising:
a base configured to support the processing container; and
a support member extending from the base;
wherein the motor mounted for pivotal movement relative to the support member.

4. The food processing system of claim 3, further comprising:
a lifter handle operatively connected to the motor and being operable to move the motor between the raised position and the lowered position.

5. The food processing system of claim 4, further comprising:
a first linkage having a first linkage member and a second linkage member, the first and second linkage members of the first linkage having respective distal ends pivotally connected to the support member, and respective proximal ends pivotally connected to a housing containing the motor.

6. The food processing system of claim 5, further comprising:
a second linkage having a first linkage member and a second linkage member, the first and second linkage members of the second linkage having respective distal ends pivotally connected to the support member, and respective proximal ends pivotally connected to the housing containing the motor.

7. The food processing system of claim 6, wherein:
the first linkage includes a rigid connection member interconnecting the first linkage member of the first linkage with the second linkage member of the first linkage; and
wherein the second linkage includes a rigid connection member interconnecting the first linkage member of the second linkage with the second linkage member of the second linkage.

8. The food processing system of claim 6, wherein:
the distal ends of the first linkage member and the second linkage member of the first and second linkages are received within vertical slots within the support member.

9. The food processing system of claim 6, wherein:
the first linkage member and the second linkage member are arranged vertically spaced from one another.

10. The food processing system of claim 4, wherein:
the lifter handle includes an actuator configured to selectively allow or restrain movement of the motor between the raised position and the lowered position.

11. The food processing system of claim 6, further comprising:
a sound enclosure, the sound enclosure being moveable between a closed position and an open position;

12. A method for food processing, comprising the steps of:
coupling a scraper assembly to a processing container such that a scraper blade of the scraper assembly is disposed within the processing container;
positioning the processing container on a base of a food processor so as to engage a blade hub of the processing container with a rotatable output shaft of a motor housed in the base;
lowering a scraper motor to drivingly connect a drive coupling of the scraper motor with a drive hub of the scraper assembly; and
actuating the scraper motor to rotate the scraper blade within the processing container.

13. The method according to claim 12, wherein:
the step of lowering the scraper motor is carried out by lowering a lifter handle operatively connected to the scraper motor.

14. The method according to claim 13, further comprising the step of:
depressing a button on the lifter handle to free the lifter handle for movement.

15. The method according to claim 13, wherein:
the scraper motor is contained within a housing pivotally connected to a support member extending upwardly from a base of the food processing system.

16. The method according to claim 15, wherein:
the housing is operatively connected to the support member by a first linkage having a first linkage member and a second linkage member, the first and second linkage members of the first linkage having respective distal ends pivotally connected to the support member, and respective proximal ends pivotally connected to the housing.

17. The method according to claim 12, wherein:
the step of lowering the scraper motor includes moving the scraper motor along an arcuate path in a downward and forward direction.

18. A food processing system, comprising:
a base having a motor;
a processing container having a motor-driven processing blade positioned at a bottom of the processing container and engageable with an output shaft of the motor in the base;
a lid receivable atop the processing container;
a scraper assembly connected to the lid and having at least one scraper blade disposed in the processing container and being configured to scrape interior sidewalls of the processing container; and
a scraper motor positioned above the processing container, the scraper motor having a rotatable drive coupling that is selectively engageable with the scraper assembly, the scraper motor being configured to rotate the at least one scraper blade upon actuation of the scraper motor;
wherein the drive coupling of the scraper motor is moveable between a raised position where the drive coupling is spaced from the scraper assembly, and a lowered position where the drive coupling is engaged with the scraper assembly.

19. The food processing system of claim 18, further comprising:
a support member extending from the base;
wherein the scraper motor is operatively connected to the support member.

20. The food processing system of claim 19, further comprising:
a first linkage having a first linkage member and a second linkage member, the first and second linkage members of the first linkage having respective distal ends pivotally connected to the support member, and respective proximal ends pivotally connected to a housing containing the scraper motor; and
a second linkage having a first linkage member and a second linkage member, the first and second linkage members of the second linkage having respective distal ends pivotally connected to the support member, and respective proximal ends pivotally connected to the housing containing the motor.

21. The food processing system of claim 20, further comprising:
a lifter handle operatively connected to the housing and being operable to move the housing and motor between the raised position and the lowered position;
wherein in the raised position, the drive coupling is positioned vertically and rearwardly from a hub of the scraper assembly.
